(19) United States
(12) Patent Application Publication
(10) Pub. No.: US 2024/0301312 A1
(43) Pub. Date: Sep. 12, 2024

(54) COMBUSTION-SUPPORTING PACKAGE STRUCTURE

(71) Applicant: Zhejiang Tanfu New Energy Co., Ltd., Quzhou (CN)

(72) Inventors: Qi ZHOU, Quzhou (CN); Yi LIU, Quzhou (CN); Jinming ZHAO, Quzhou (CN); Weilin FANG, Quzhou (CN)

(73) Assignee: Zhejiang Tanfu New Energy Co., Ltd., Quzhou (CN)

(21) Appl. No.: 18/602,049

(22) Filed: Mar. 12, 2024

(30) Foreign Application Priority Data
Mar. 12, 2023 (CN) 202320454848. 6

(51) Int. Cl. C10L 5/36; C10L 5/44

(52) U.S. Cl. CPC C10L 5/368; C10L 5/447

(57) ABSTRACT

A combustion-supporting package structure includes a main body, gas channels, and a ventilation duct. An ignition member is arranged below the main body, the gas channels are provided inside a bottom end of the main body, the ventilation duct is provided in a middle of the bottom end of the main body, charcoal is arranged above the main body, an end cover is arranged above the charcoal, a placing cavity is provided inside a top end of the end cover, and ventilation holes are provided inside the top end of the end cover at a front end and a rear end of the placing cavity. A stainless steel clip is arranged above the end cover. According to the combustion-supporting package structure, thermal convection is generated in the gas channels, such that the charcoal is continuously and stably burn, and a combustion-supporting gas enters the main body through the ventilation duct.

### CROSS REFERENCE TO THE RELATED APPLICATIONS

This application is based upon and claims priority to Chinese Patent Application No. 202320454848.6, filed on Mar. 12, 2023, the entire contents of which are incorporated herein by reference.

### TECHNICAL FIELD

The present disclosure relates to the technical field of coal combustion, and in particular, to a combustion-supporting package structure.

### BACKGROUND

There are three types of charcoal: quick-burning charcoal, raw charcoal, and machine-made charcoal. Flammable barbecue charcoal is provided with a flammable layer on its surface, so it is easier to ignite than ordinary raw charcoal, but is expensive. The ordinary raw charcoal is cheap, but is non-uniform in size, generates non-uniform firepower during barbecuing, has a short burning time, and generates heavy smoke during barbecuing due to insufficient carbonization. Machine-made barbecue charcoal is prepared by mixing charcoal and an adhesive and is pressed into a hollow polygonal shape. Such barbecue charcoal is uniform in size, has a long burning time, generates uniform firepower and no smoke, and is not expensive. Many professional barbecue restaurants choose this type of barbecue charcoal, but the barbecue charcoal is not easy to ignite.

An existing ignition method is to ignite the barbecue charcoal by means of solid alcohol or a flamethrower with accessories such as heat-insulating gloves and a metal clip, and it takes about 20 minutes from ignition to use, which is not conducive to convenient use by consumers.

In order to solve the problem of difficult ignition of the machine-made charcoal, it is desirable to develop a novel ignition method, which can easily ignite machine-made charcoal that is originally ignited by professionals with the help of special tools such as a stainless steel clip and heat-insulating gloves, as well as ignition auxiliary materials such as an alcohol block, thereby greatly improving convenience, simplifying a use method, reducing consumption of unnecessary disposable accessories, and improving user experience in an all-round way.

### SUMMARY

An objective of the present disclosure is to provide a combustion-supporting package structure, to solve the problem that machine-made charcoal is not easy to ignite in the above background.

To achieve the above objective, the present disclosure provides the following technical solution: A combustion-supporting package structure includes a main body and further includes gas channels and a ventilation duct, where

an ignition member is arranged below the main body, the gas channels are provided inside a bottom end of the main body, the ventilation duct is provided in a middle of the bottom end of the main body, charcoal is arranged above the main body, an end cover is arranged above the charcoal, a placing cavity is provided inside a top end of the end cover, ventilation holes are provided inside the top end of the end cover at a front end and a rear end of the placing cavity, and a stainless steel clip is arranged above the end cover.

Preferably, the gas channels communicate with each other, and the gas channels communicate with the ventilation duct.

Preferably, a top end of the ventilation duct passes through the main body, and the top end of the ventilation duct extends to an interior of the main body.

Preferably, the stainless steel clip is matched with the placing cavity, and the end cover is matched with a top end of the main body.

Preferably, a bottom end of the ventilation hole runs through the end cover, and the bottom end of the ventilation hole extends to a bottom end of the end cover.

Compared with the prior art, the present disclosure has the following beneficial effects: An end cover covers a top end of a main body, and a whole device is placed into fire, so that an ignition member is ignited. Charcoal is ignited by means of the ignited ignition member and thermal convection is generated in gas channels, which helps the charcoal continuously and stably burn, and the charcoal in the main body can be ignited in three to five minutes. During storage, a plurality of main bodies can be stacked with each other, improving a storage space.

### BRIEF DESCRIPTION OF THE DRAWINGS

FIG. 1 is a perspective schematic structural diagram of the present disclosure;

FIG. 2 is a schematic structural front sectional view of the present disclosure;

FIG. 3 is a schematic structural front view of the present disclosure;

FIG. 4 is a schematic structural side view of the present disclosure; and

FIG. 5 is a schematic structural top view of the present disclosure.

In the figures: 1. Gas channel; 2. Ignition member; 3. Main body; 4. Ventilation duct; 5. Ventilation hole; 6. Stainless steel clip; 7. Placing cavity; 8. End cover; 9. Charcoal.

### DETAILED DESCRIPTION OF THE EMBODIMENTS

The technical solutions in embodiments of the present disclosure are described below clearly and completely with reference to the accompanying drawings in the embodiments of the present disclosure. Apparently, the described embodiments are merely some, rather than all of the embodiments of the present disclosure. All other embodiments derived from the embodiments of the present disclosure by those of ordinary skill in the art without creative efforts shall fall within the protection scope of the present disclosure.

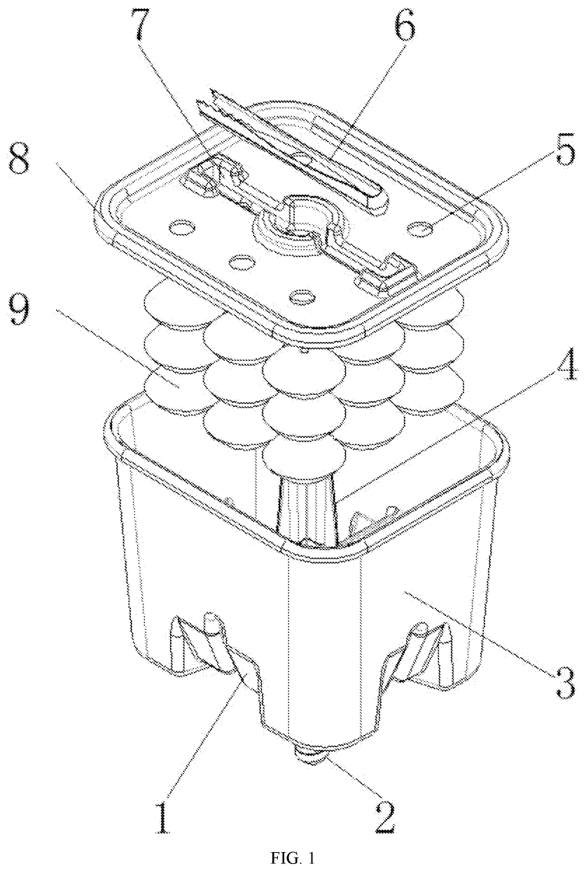

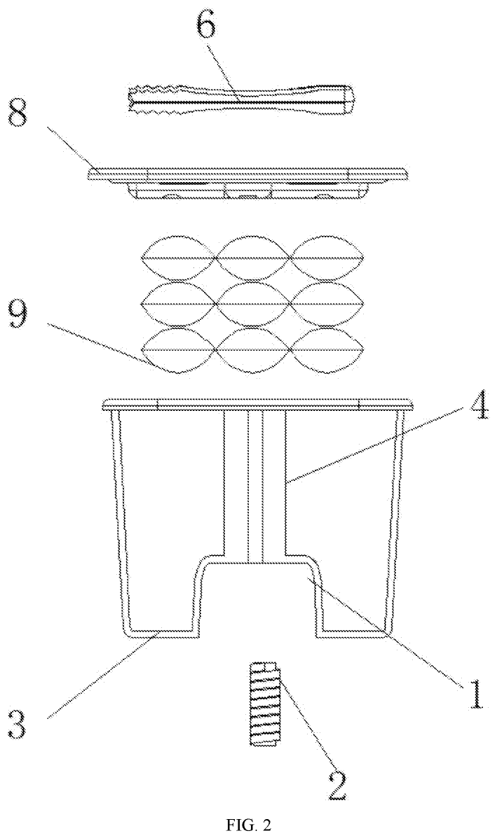

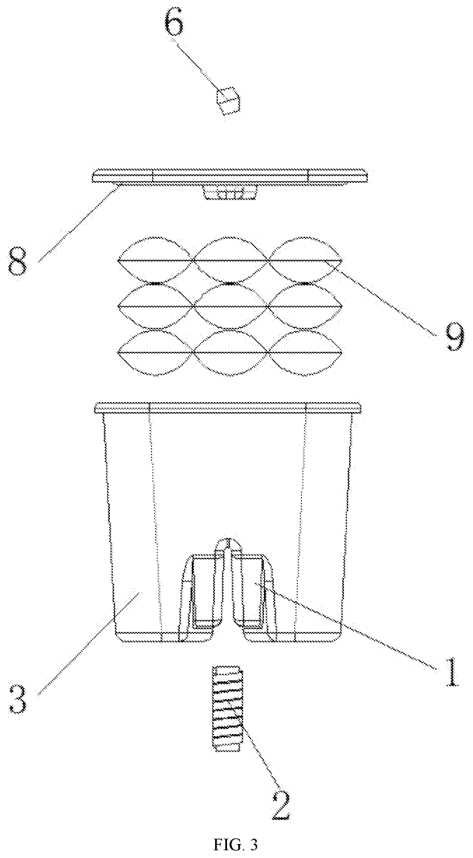

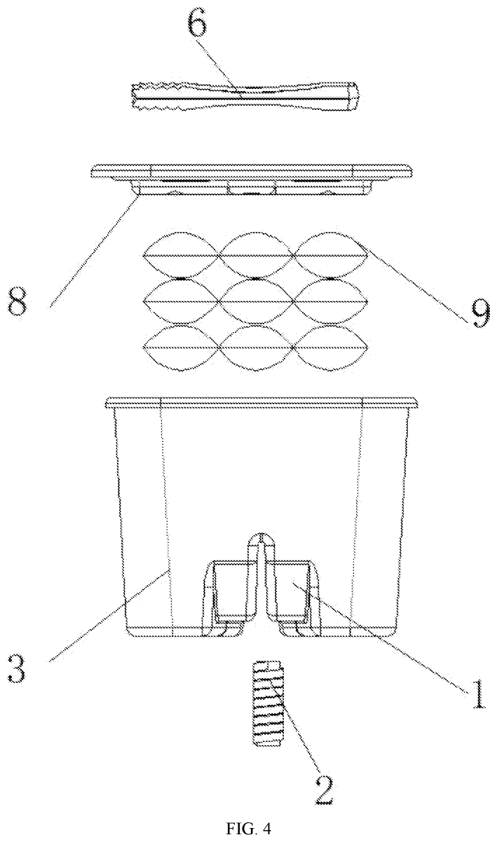

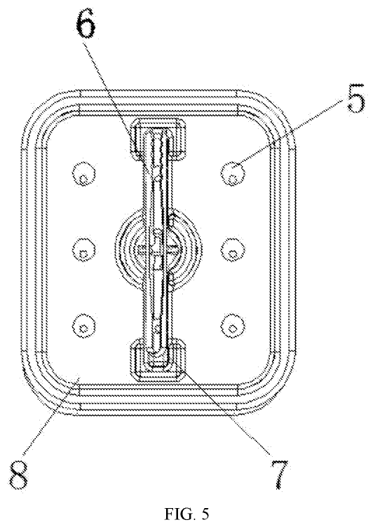

Embodiment 1: Referring to FIG. 1-5, a combustion-supporting package structure includes main body 3 and further includes gas channels 1 and ventilation duct 4.

Ignition member 2 is arranged below the main body 3, and the gas channels 1 are provided inside a bottom end of the main body 3. The ventilation duct 4 is provided in a middle of the bottom end of the main body 3, and charcoal 9 is arranged above the main body 3. End cover 8 is arranged above the charcoal 9, and placing cavity 7 is provided inside a top end of the end cover 8. Ventilation holes 5 are provided inside the top end of the end cover 8 at a front end and a rear end of the placing cavity 7. Stainless steel clip 6 is arranged above the end cover 8.

The gas channels 1 communicate with each other, and the gas channels 1 communicate with the ventilation duct 4.

A top end of the ventilation duct 4 passes through the main body 3, and the top end of the ventilation duct 4 extends to an interior of the main body 3.

The stainless steel clip 6 is matched with the placing cavity 7, and the end cover 8 is matched with a top end of the main body 3.

A bottom end of the ventilation hole 5 runs through the end cover 8, and the bottom end of the ventilation hole 5 extends to a bottom end of the end cover 8.

Specifically, as shown in FIGS. 1, 2, 3, 4 and 5, when this mechanism is used, the charcoal 9 is clipped into the main body 3 by the stainless steel clip 6, and then the ignition member 2 is placed below the main body 3. A whole device is placed into fire, and the ignition member 2 is ignited to help the charcoal burn.

Working principle: A worker takes the stainless steel clip 6 out of the placing cavity 7, clips the charcoal 9 into the main body 3 by means of the stainless steel clip 6, then places the ignition member 2 below the main body 3, covers the top end of the main body 3 with the end cover 8, places the whole device into the fire to ignite the ignition member 2, and ignites the charcoal 9 under the action of the ignited ignition member 2 and the gas channels 1.

It is obvious to those skilled in the art that the present disclosure is not limited to details of the above exemplary embodiments, and the present disclosure can be implemented in other specific forms without departing from the spirit or basic features of the present disclosure. Therefore, the embodiments should be regarded as exemplary and non-limiting in every respect, and the scope of the present disclosure is defined by the appended claims rather than the above description. Therefore, all changes falling within the meaning and scope of equivalent elements of the claims should fall within the scope of the present disclosure. Any reference signs in the claims should not be considered as limiting the claims concerned.

1. A combustion-supporting package structure, comprising a main body, gas channels, and a ventilation duct; wherein
an ignition member is arranged below the main body, the gas channels are provided inside a bottom end of the main body, the ventilation duct is provided in a middle of the bottom end of the main body, charcoal is arranged above the main body, an end cover is arranged above the charcoal, a placing cavity is provided inside a top end of the end cover, and ventilation holes are provided inside the top end of the end cover at a front end and a rear end of the placing cavity.

2. The combustion-supporting package structure according to claim 1, wherein the gas channels communicate with each other, and the gas channels communicate with the ventilation duct.

3. The combustion-supporting package structure according to claim 1, wherein a top end of the ventilation duct passes through the main body, and the top end of the ventilation duct extends to an interior of the main body.

4. The combustion-supporting package structure according to claim 1, wherein a stainless steel clip is arranged above the end cover, the stainless steel clip is matched with the placing cavity, and the end cover is matched with a top end of the main body.

5. The combustion-supporting package structure according to claim 1, wherein a bottom end of each of the ventilation holes runs through the end cover, and the bottom end of each of the ventilation holes extends to a bottom end of the end cover.
